(19) United States
(12) Patent Application Publication
(10) Pub. No.: US 2025/0026174 A1
(43) Pub. Date: Jan. 23, 2025

(54) PORTABLE HVAC SYSTEM FOR VEHICLE

(71) Applicant: GM Global Technology Operations LLC, Detroit, MI (US)

(72) Inventors: Kenneth Wonseok Choi, Troy, MI (US); Vincent Keanan Traina, Bloomfield Hills, MI (US); Thiago Canola Afonso, Sterling Heights, MI (US)

(73) Assignee: GM Global Technology Operations LLC, Detroit, MI (US)

(21) Appl. No.: 18/355,723

(22) Filed: Jul. 20, 2023

(51) Int. Cl. B60H 1/00

(52) U.S. Cl. CPC B60H 1/00535; B60H 1/00207; B60H 2001/00214

(57) ABSTRACT

A vehicle includes a duct in fluid communication with a cabin of the vehicle and a heating, ventilating, and air conditioning (HVAC) system including a housing and an outlet configured to expel conditioned air from the housing, the HVAC system movable relative to the vehicle between an engaged state having the outlet fluidly coupled with the duct and a disengaged state having the outlet decoupled from the duct.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against present disclosure.

The present disclosure relates generally to heating and cooling systems and, more particularly, to a portable heating and cooling system for use in a vehicle.

Residential homes and vehicles typically include heating and cooling systems that selectively heat or cool a residence or vehicle when required. Such heating and cooling systems are typically referred to as heating, ventilation, and air conditioning (HVAC) systems that control the temperature, humidity and, in some cases, the purity of the air in a residence or vehicle.

HVAC systems typically include an evaporator, a compressor, a condenser, and piping that fluidity couples the evaporator, the compressor, and the condenser in a closed-loop system. In operation, the compressor serves to circulate a refrigerant within the closed-loop system to cause the refrigerant to circulate through both the evaporator and the condenser. Specifically, the compressor compresses vaporized refrigerant received from the evaporator and directs the vaporized refrigerant, once pressurized at the compressor, to the condenser. At the condenser, the high-pressure, vaporized refrigerant circulates through a series of coils fluidly coupled to the piping and changes state from a vapor refrigerant to a liquid refrigerant. The refrigerant changes state from a vapor or gas to a liquid due to air being circulated over the coils by a fan associated with the condenser. Namely, when the air passes over the coils of the condenser, heat associated with the refrigerant circulating within the coils of the condenser is absorbed by the air flowing over the coils of the condenser, which causes the refrigerant circulating within the condenser to cool and change phase from a gas to a liquid and causes the air passing over the coils to be heated.

The liquid refrigerant exits the condenser and is received by the evaporator. As with the condenser, the evaporator typically includes a series of coils that are fluidly coupled to the piping of the HVAC system. The liquid refrigerant circulates through the coils of the evaporator due to the pressure exerted on the refrigerant by the compressor. As with the condenser, the evaporator is typically associated with a fan, which forces air over the coils of the evaporator. In so doing, heat within the air flowing over the coils of the evaporator is absorbed by the refrigerant circulating within the coils of the evaporator. The absorbed heat causes the refrigerant to change phase from a liquid to a gas which, in turn, causes the air flowing over the coils and through the evaporator to be cooled. The vaporized refrigerant exiting the evaporator is returned to the compressor to start the cycle over again. In the context of a residential HVAC system, the blower motor associated with the furnace acts as the evaporator fan, which causes the cooled air from the evaporator to be directed into a home or residence via a series of ductwork.

In the context of an automotive application, a vehicle's HVAC system functions in a similar manner as a residential HVAC system. However, a vehicle HVAC system is more compact as compared to a residential heating system, as a vehicle HVAC system is typically packaged within an instrument panel (IP) of a vehicle. Further, a vehicle HVAC system doesn't rely on a furnace to provide heating to a vehicle cabin but, rather, relies on heat from a vehicle engine to provide heat to the vehicle cabin.

While conventional vehicle HVAC systems adequately provide a vehicle cabin with conditioned air, such vehicle HVAC systems can be difficult to package within an IP of the vehicle. Further, packaging a vehicle HVAC system within an IP of a vehicle can be difficult given the number of components that must be packaged within a conventional vehicle IP. Finally, while conventional vehicle HVAC systems adequately condition air for a vehicle cabin, such HVAC systems are permanently installed in the vehicle and, as such, can only be used to condition air within the particular vehicle and associated vehicle cabin.

### SUMMARY

In one configuration, a vehicle includes a duct in fluid communication with a cabin of the vehicle and a heating, ventilating, and air conditioning (HVAC) system including a housing and an outlet configured to expel conditioned air from the housing, the HVAC system movable relative to the vehicle between an engaged state having the outlet fluidly coupled with the duct and a disengaged state having the outlet decoupled from the duct.

The vehicle may include one or more of the following optional features. For example, the HVAC system may be slidable relative to the vehicle between the engaged state and the disengaged state. Additionally or alternatively, the vehicle may include a frunk, the HVAC system being disposed in the frunk in the engaged state. The HVAC system may be selectively attached to a platform within the frunk, the platform slidable relative to the frunk to move the HVAC system between the engaged state and the disengaged state. The HVAC system may include a condenser, an evaporator, and a compressor disposed within the housing.

In one configuration, the HVAC system may be automatically moved into the engaged state when the HVAC system is moved a predetermined distance relative to the vehicle. In this configuration, the housing may include an electrical contact, the electrical contact automatically moved into contact with an electrical contact of the vehicle when the HVAC system is moved the predetermined distance relative to the vehicle and into the engaged state. The vehicle may supply power to the HVAC system via the electrical contact of the vehicle and the electrical contact of the HVAC system when the HVAC system is in the engaged state.

In another configuration, a vehicle includes a duct in fluid communication with a cabin of the vehicle and a heating, ventilating, and air conditioning (HVAC) system including a housing containing an evaporator, a condenser, and a compressor, the housing movable relative to the vehicle between an engaged state coupled with the duct and a disengaged state decoupled from the duct.

The vehicle may include one or more of the following optional features. For example, the HVAC system may be slidable relative to the vehicle between the engaged state and the disengaged state. Additionally or alternatively, the vehicle may include a frunk, the HVAC system disposed in the frunk in the engaged state. The HVAC system may be selectively attached to a platform within the frunk, the platform slidable relative to the frunk to move the HVAC system between the engaged state and the disengaged state. The housing may include a handle configured to assist in removing the HVAC system from the vehicle.

In one configuration, the HVAC system may be automatically moved into the engaged state when the HVAC system is moved a predetermined distance relative to the vehicle. In this configuration, the housing may include an electrical contact, the electrical contact automatically moved into contact with an electrical contact of the vehicle when the HVAC system is moved the predetermined distance relative to the vehicle and into the engaged state. The vehicle may supply power to the HVAC system via the electrical contact of the vehicle and the electrical contact of the HVAC system when the HVAC system is in the engaged state.

In yet another configuration, a vehicle includes a duct in fluid communication with a cabin of the vehicle, an electrical contact receiving power from a power source of the vehicle, and a heating, ventilating, and air conditioning (HVAC) system including a housing, an outlet configured to selectively expel conditioned air from the housing to the duct, and an electrical contact, the HVAC system movable relative to the vehicle between an engaged state having the electrical contact electrically coupled with the electrical contact of the vehicle and a disengaged state having the electrical contact of the housing decoupled from the electrical contact of the vehicle.

The vehicle may include one or more of the following optional features. For example, the HVAC system may be slidable relative to the vehicle between the engaged state and the disengaged state. Additionally or alternatively, the vehicle may include a frunk, the HVAC system disposed in the frunk in the engaged state. The outlet of the HVAC system may be fluidly coupled to the duct in the engaged state and is decoupled from the duct in the disengaged state.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle showing a portable HVAC unit of the vehicle disposed within a frunk of the vehicle and in an engaged state;

FIG. 2 is a perspective view of the vehicle of FIG. 1 showing a door/gate of the frunk in an open state and the portable HVAC unit in a disengaged state;

FIG. 3 is a front perspective view of the portable HVAC system of FIG. 1:

FIG. 4 is a rear perspective view of the portable HVAC unit of FIG. 1:

FIG. 4A is a front view of the portable HVAC system of FIG. 1 with part of a housing removed to schematically show internal components of the HVAC system:

FIG. 5 is a rear perspective view of the vehicle of FIG. 1 with a lift gate of the vehicle shown in an open position and the portable HVAC unit in a storage position; and

FIG. 6 is a rear perspective view of the vehicle of FIG. 1 with a lift gate in an open position and the portable HVAC unit being used in an area remote from the vehicle.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising.” “including,” and “having.” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on.” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC): a digital, analog, or mixed analog/digital discrete circuit: a digital, analog, or mixed analog/digital integrated circuit: a combinational logic circuit: a field programmable gate array (FPGA): a processor (shared, dedicated, or group) that executes code: memory (shared, dedicated, or group) that stores code executed by a processor: other suitable hardware components that provide the described functionality: or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory. Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices: magnetic disks, e.g., internal hard disks or removable disks: magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well: for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user: for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

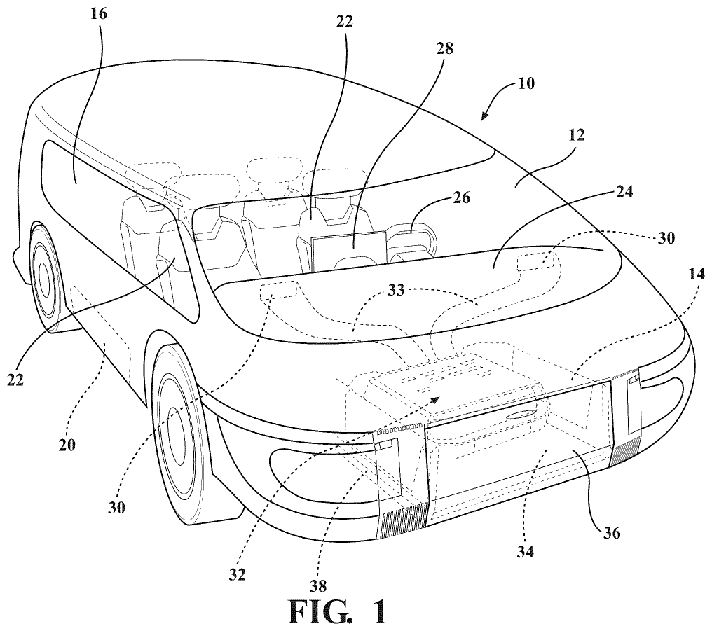

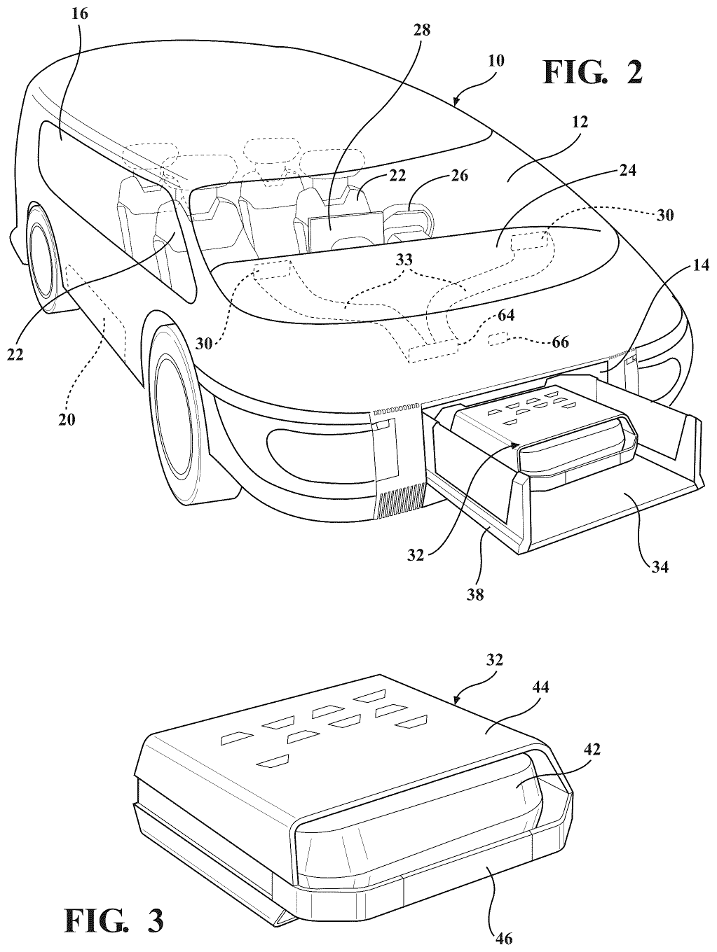

With particular reference to FIGS. 1 and 2, a vehicle 10 is provided. The vehicle 10 includes a cabin 12, a frunk 14 located in a forward region of the vehicle 10, and a storage area 16 located in a rearward area of the vehicle 10. The frunk 14 is located in an area of the vehicle 10 that would typically house an engine of the vehicle 10. However, the vehicle shown in FIG. 1 is an electric vehicle (EV), which may be driven by one or more electric motors (none shown) that are driven by a battery 20 of the vehicle 10. While the vehicle 10 will be described hereinafter as being an EV, the vehicle 10 could alternatively be powered by an internal combustion engine (ICE) or may be a hybrid-electric vehicle, which includes both an ICE as well as one or more electric motors that work in conjunction with one another to power the vehicle 10.

The cabin 12 of the vehicle 10 is disposed generally between the frunk 14 and the storage area 16. The cabin 12 includes a series of seats 22 and an instrument panel (IP) 24. The instrument panel 24 opposes a driver seat and a passenger seat of the seats 22 and typically provides a driver and/or passenger with the ability to control various aspects of the vehicle. For example, the IP 24 typically supports a mechanism that allows the driver to control and steer the vehicle 10 such as, for example, a steering wheel 26. The IP 24 may additionally include a series of controls, gauges, and displays 28 that allow the driver and/or passenger to control functions of the vehicle 10 and to monitor operating conditions of the vehicle 10 such as, for example, vehicle speed.

The IP 24 may additionally include one or more vents 30, which provide the cabin 12 with conditioned air. The conditioned air provided to the cabin 12 by the vents 30 may be controlled via one or more of the controls or displays 28 associated with the IP 24.

The conditioned air provided to the cabin 12 via the vents 30 is supplied by a HVAC system 32. The HVAC system 32 is in fluid communication with the vents 30 and is disposed within the frunk 14.

The HVAC system 32 is a portable HVAC system, which may be used in conjunction with the vehicle 10 or outside of the vehicle 10. When the HVAC system 32 is used in conjunction with the vehicle 10, the HVAC system 32 is received by and disposed within the frunk 14. Specifically, the HVAC system 32 is disposed on a slidable platform or drawer 34 within the frunk 14, which allows the HVAC system 32 to be moved between an engaged state (FIG. 1) and a disengaged state (FIG. 2). When the HVAC system 32 is in an engaged state, the HVAC system 32 is fluidly coupled to the vents 30 via ductwork 33 and can provide conditioned air to the cabin 12 via the vents 30. When the slidable drawer 34 is moved into a disengaged state (FIG. 2), the HVAC system 32 is disengaged from the vents 30 and, as such, cannot supply conditioned air to the cabin 12 via the ductwork 33 and vents 30.

The slidable drawer 34 is moved between the engaged state (FIG. 1) and the disengaged state (FIG. 2) by first moving a door/gate 36 of the frunk 14 from a closed position (FIG. 1) to an open position (FIG. 2). Once the door/gate 36 of the frunk 14 is moved into the open position, access to the slidable drawer 34 and the HVAC system 32 is permitted. At this point, a force may be exerted on the slidable drawer 34 to move the slidable drawer 34 from the engaged state (FIG. 1) to the disengaged state (FIG. 2). The slidable drawer 34 may include one or more tracks 38, which allow the slidable drawer 34 to be translated between the engaged state and the disengaged state relative to the frunk 14 of the vehicle 10.

The HVAC system 32 may be positioned on and within the slidable drawer 34 such that the HVAC system 32 is fixed for movement with the slidable drawer 34 between the engaged state and the disengaged state. When the HVAC system 32 is disposed on the slidable drawer 34 and the slidable drawer 34 is in the engaged state, the HVAC system 32 is automatically fluidly coupled to the ductwork 33 and the vents 30 and is automatically coupled to the battery 20 of the vehicle 10.

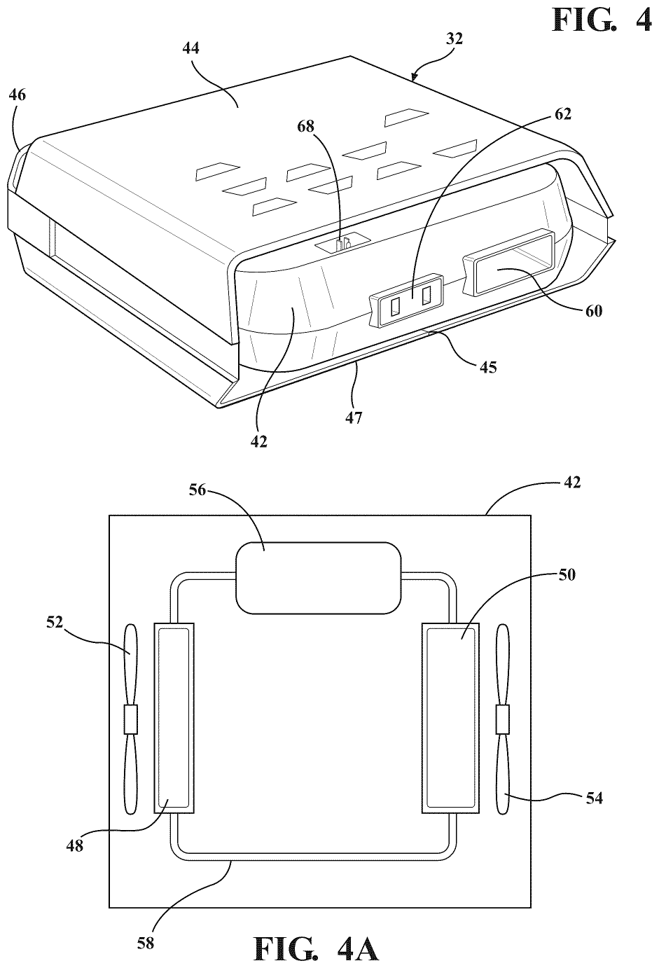

With particular reference to FIGS. 3 and 4, the HVAC system 32 is shown as including a housing 42 and a carrier 44 that supports the housing 42. In one configuration, the housing 42 is formed from a hard, plastic material while the carrier 44 is formed by a metal material. The carrier 44 may surround the housing 42 and, in one configuration, may be formed from a single sheet of metal that is bent into the configuration shown in FIGS. 3 and 4.

The sheet of metal forming the carrier 44 is formed into the shape shown in FIGS. 3 and 4 to accommodate the size and shape of the housing 42. Namely, the carrier 44 is formed into the shape shown in FIGS. 3 and 4 to receive and support the housing 42 within the carrier 44 and may include ends 45 of the sheet of metal that abut and oppose one another on a bottom side 47 of the carrier 44 (FIG. 4). As shown, the carrier 44 includes a handle 46 that allows a user to easily grasp and carry the HVAC system 32. The handle 46 may be formed from the same or a different plastic material than the housing 42 or, alternatively, may be formed from a metal material that is attached to the carrier 44 in the position shown in FIGS. 3 and 4.

With reference to FIG. 4A, the HVAC system 32 includes an evaporator 48, a condenser 50, an evaporator fan 52, a condenser fan 54, and a compressor 56 that are fluidly coupled to one another via a series of conduits 58. The evaporator 48, condenser 50, evaporator fan 52, condenser fan 54, compressor 56, and conduits 58 are all located within the housing 42 and cooperate to provide the cabin 12 with conditioned air, as will be described in greater detail blow:

In operation, the compressor 56 delivers high-pressure, vapor or gaseous refrigerant to the condenser 50 via a conduit 58. The high-pressure, gaseous refrigerant received by the condenser 50 circulates through coils (not shown) of the condenser 50 and, in so doing, changes phase from a gas to a liquid. Specifically, the condenser fan 54 directs a flow of air over the coils of the condenser 50, which causes heat disposed within the refrigerant to be absorbed by the air passing over the coils of the condenser 50, thereby cooling the refrigerant and causing the refrigerant to change phase from a gas to a liquid. The air passing through the condenser 50 is heated and may be used to heat the cabin 12 when the HVAC system 32 is in the engaged state (FIG. 1) or an area external from the cabin 12 when the HVAC system 32 is in the disengaged state (FIGS. 2 and 6).

The liquid refrigerant is directed to the evaporator 48 and circulates through coils (not shown) of the evaporator 48. The evaporator fan 52 directs air over the coils of the evaporator 48 and, in so doing, causes the refrigerant to absorb heat from the air and change phase from a liquid to a gas. The gaseous refrigerant is then directed to the compressor 56 to begin the cycle anew. The air passing through the evaporator 48 is cooled, as a result of the refrigerant absorbing heat from the air and may be used to cool the cabin 12 when the HVAC system 32 is in the engaged state (FIG. 1) or an area external from the cabin 12 when the HVAC system 32 is in the disengaged state (FIGS. 2 and 6).

When the HVAC system 32 is in the engaged state, the air directed over the evaporator 48 by the evaporator fan 52 may be directed into the cabin 12 via the ductwork 33 and vents 30 to provide the cabin 12 with cooled air. Similarly, should the cabin 12 require heat, the air passing over the coils of the condenser 50 by the condenser fan 54 may be directed into the cabin 12 via the ductwork 33 and vents 30 to heat the cabin 12. Again, the cooled air is created by air passing through the evaporator 48 being cooled by the refrigerant circulating within the coils of the evaporator 48 absorbing heat from the air passing therethrough. The heated air is created by air passing through the condenser 50 absorbing heat from the refrigerant circulating within the coils of the condenser 50.

With particular reference to FIG. 4, the housing 42 is shown as including an outlet 60) and an electrical contact 62. The outlet 60 directs conditioned air from the evaporator 48 and/or condenser 50 to the vents 30 via the ductwork 33 when the HVAC system 32 is in the engaged state. Specifically, the outlet 60 is automatically fluidly coupled to a port 64 (FIG. 2) of the ductwork 33 when the slidable drawer 34 positions the HVAC system 32 in the engaged position. The port 64 is fluidly coupled to the vents 30 via the ductwork 33 such that conditioned air produced by the HVAC system 32 may be directed to the cabin 12 via the outlet 60 of the HVAC system 32, the port 64, the ductwork 33, and the vents 30 of the IP 24.

The electrical contact 62 is disposed adjacent to the outlet 60 and is positioned relative to an electrical contact 66 of the vehicle 10 such that when the slidable drawer 34 positions the HVAC system 32 in the engaged state (FIG. 1), the electrical contact 62 of the HVAC system 32 is automatically placed in contact with the electrical contact 66 of the vehicle 10. Placing the electrical contact 62 of the HVAC system 32 in contact with the electrical contact 66 of the vehicle 10, allows the battery 20 of the vehicle 10 to supply power to the HVAC system 32. The power supplied to the HVAC system 32 by the battery 20 of the vehicle 10 allows the HVAC system 32 to function as previously described. Namely, the power supplied to the HVAC system 32 allows the compressor 56 to circulate refrigerant between the evaporator 48 and the condenser 50 and, further, allows the evaporator fan 52 and the condenser fan 54 to direct air over and through the coils of the evaporator 48 and the condenser 50, respectively.

In operation, a user may open the door/gate 36 of the frunk 14 to provide access to the slidable drawer 34. A force may be applied to the slidable drawer 34 once the door/gate 36 is open to move the slidable drawer 34 into an extended position. Once the slidable drawer 34 is moved into an extended position, the HVAC system 32 may be placed on the slidable drawer 34 and fixed for movement with the slidable drawer 34. A force may then be applied to the slidable drawer 34 to move the slidable drawer 34 into the engaged state (FIG. 1).

Once the HVAC system 32 and slidable drawer 34 are moved into the engaged state, the outlet 60 of the HVAC system 32 is automatically fluidly coupled to the port 64 of the vehicle 10 and the electrical contact 62 of the HVAC system 32 is automatically placed in contact with the electrical contact 66 of the vehicle 10. At this point, the door/gate 36 of the frunk 14 may be closed and the HVAC system 32 may provide conditioned air to the cabin 12 via the outlet 60 of the HVAC system 32, the port 64, the ductwork 33, and the vents 30 of the IP 24.

The HVAC system 32 is a so-called portable HVAC system 32 in that the HVAC system 32 may be used in conjunction with the vehicle 10 or in a separate location from the vehicle 10. For example, the door/gate 36 of the frunk 14 may be opened to expose the HVAC system 32 and the slidable drawer 34. At this point, the slidable drawer 34 may be moved into the extended state (FIG. 2) to provide access to the HVAC system 32. When the slidable drawer 34 is moved into the extended state, the outlet 60 of the HVAC system 32 is automatically disconnected from the port 64 of the vehicle 10 and the electrical contact 62 of the HVAC system 32 is automatically disconnected from the electrical contact 66 of the vehicle 10. At this point, the HVAC system 32 may be removed from the slidable drawer 34 for use in an area external to the vehicle 10.

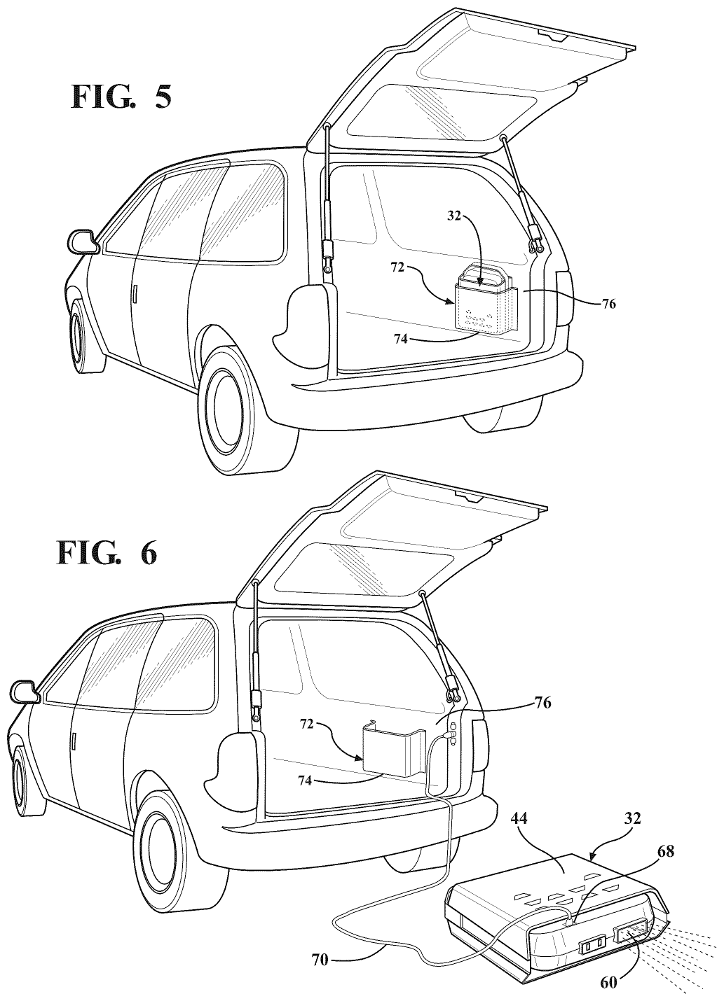

With particular reference to FIGS. 5 and 6, the HVAC system 32 is shown as being used in an area external to the vehicle system 10. In one configuration, the HVAC system 32 includes one or more outlets 68, which allows the HVAC system 32 to be powered by an external power source via a power cord 70. As shown in FIG. 6, a power cord 70 may extend from the vehicle 10 and may be received by an outlet 68 of the HVAC system 32 to allow the vehicle 10 to provide power to the HVAC system 32 when the HVAC system 32 is used in an area remote from the vehicle 10. Once the cord 70 is attached to an outlet 68 of the HVAC system 32 and to the vehicle 10, the HVAC system 32 may provide conditioned air to a location external from the vehicle 10 via the outlet 60. For example, the HVAC system may be used to provide conditioned air in a tent (not shown) disposed in proximity to the vehicle 10. While the power cord 70 is described and shown as being attached to the HVAC system 32 at the outlet 68, the power cord 70 could alternatively be attached to the HVAC system 32 at the electrical contact 62.

Finally, while the HVAC system 32 may be used in an area remote from the vehicle 10, when the cabin 12 does not require conditioned air from the HVAC system 32, the HVAC system 32 may be stored within a storage compartment 72 of the vehicle 10. The storage compartment 72 may be located in the storage area 16 of the vehicle 10 and may include a recess or pocket 74 formed in a panel 76 of the vehicle 10 or protruding from the panel 76, as shown in FIG. 5. The recess or pocket 74 may be located in the storage area 16 of the vehicle 10 to allow the recess or pocket 74 to matingly receive the carrier 44 of the HVAC system 32. Once the carrier 44 of the HVAC system 32 is disposed within the recess or pocket 74, the HVAC system 32 is secured to the panel 76 and is in a storage state located within the storage area 16.

As described, the HVAC system 32 may be used in conjunction with the vehicle 10 to provide the cabin 12 with conditioned air. Alternatively, the HVAC system 32 may be removed from the vehicle 10 to allow the HVAC system 32 to provide conditioned air to an area located remotely from the vehicle 10. Finally, the HVAC system 32 may provide a location where a user may plug in one or more external devices to power the external devices when the HVAC system 32 is located remotely from the vehicle 10 and is used to provide conditioned air to a space located remotely from the vehicle 10. For example, in the above example with respect to the HVAC system 32 providing conditioned air to a tent, one or more occupants of the tent may wish to use the HVAC system 32 to power a device such as, for example, a cellular phone or tablet.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a duct in fluid communication with a cabin of the vehicle; and
a heating, ventilating, and air conditioning (HVAC) system including a housing and an outlet configured to expel conditioned air from the housing, the HVAC system movable relative to the vehicle between an engaged state having the outlet fluidly coupled with the duct and a disengaged state having the outlet decoupled from the duct.

2. The vehicle of claim 1, wherein the HVAC system is slidable relative to the vehicle between the engaged state and the disengaged state.

3. The vehicle of claim 1, wherein the vehicle includes a frunk, the HVAC system disposed in the frunk in the engaged state.

4. The vehicle of claim 3, wherein the HVAC system is selectively attached to a platform within the frunk, the platform slidable relative to the frunk to move the HVAC system between the engaged state and the disengaged state.

5. The vehicle of claim 1, wherein the HVAC system includes a condenser, an evaporator, and a compressor disposed within the housing.

6. The vehicle of claim 1, wherein the HVAC system is automatically moved into the engaged state when the HVAC system is moved a predetermined distance relative to the vehicle.

7. The vehicle of claim 6, wherein the housing includes an electrical contact, the electrical contact automatically moved into contact with an electrical contact of the vehicle when the HVAC system is moved the predetermined distance relative to the vehicle and into the engaged state.

8. The vehicle of claim 7, wherein the vehicle supplies power to the HVAC system via the electrical contact of the vehicle and the electrical contact of the HVAC system when the HVAC system is in the engaged state.

9. A vehicle comprising:
a duct in fluid communication with a cabin of the vehicle; and
a heating, ventilating, and air conditioning (HVAC) system including a housing containing an evaporator, a condenser, and a compressor, the housing movable relative to the vehicle between an engaged state coupled with the duct and a disengaged state decoupled from the duct.

10. The vehicle of claim 9, wherein the HVAC system is slidable relative to the vehicle between the engaged state and the disengaged state.

11. The vehicle of claim 9, wherein the vehicle includes a frunk, the HVAC system disposed in the frunk in the engaged state.

12. The vehicle of claim 11, wherein the HVAC system is selectively attached to a platform within the frunk, the platform slidable relative to the frunk to move the HVAC system between the engaged state and the disengaged state.

13. The vehicle of claim 9, wherein the housing includes a handle configured to assist in removing the HVAC system from the vehicle.

14. The vehicle of claim 9, wherein the HVAC system is automatically moved into the engaged state when the HVAC system is moved a predetermined distance relative to the vehicle.

15. The vehicle of claim 14, wherein the housing includes an electrical contact, the electrical contact automatically moved into contact with an electrical contact of the vehicle when the HVAC system is moved the predetermined distance relative to the vehicle and into the engaged state.

16. The vehicle of claim 15, wherein the vehicle supplies power to the HVAC system via the electrical contact of the vehicle and the electrical contact of the HVAC system when the HVAC system is in the engaged state.

17. A vehicle comprising:
a duct in fluid communication with a cabin of the vehicle;
an electrical contact receiving power from a power source of the vehicle; and
a heating, ventilating, and air conditioning (HVAC) system including a housing, an outlet configured to selectively expel conditioned air from the housing to the duct, and an electrical contact, the HVAC system movable relative to the vehicle between an engaged state having the electrical contact electrically coupled with the electrical contact of the vehicle and a disengaged state having the electrical contact of the housing decoupled from the electrical contact of the vehicle.

18. The vehicle of claim 17, wherein the HVAC system is slidable relative to the vehicle between the engaged state and the disengaged state.

19. The vehicle of claim 17, wherein the vehicle includes a frunk, the HVAC system disposed in the frunk in the engaged state.

20. The vehicle of claim 17, wherein the outlet of the HVAC system is fluidly coupled to the duct in the engaged state and is decoupled from the duct in the disengaged state.
